(19) United States
(12) Patent Application Publication
(10) Pub. No.: US 2013/0229129 A1
(43) Pub. Date: Sep. 5, 2013

(54) METHOD AND DEVICE FOR DRIVING AN HID LAMP

(71) Applicants: Johannes Petrus Wernars, Megen (NL); Marcus Cornelis Van Meel, Helmond (NL); Roy Hendrik Anna Maria Van Zundert, Eindhoven (NL)

(72) Inventors: Johannes Petrus Wernars, Megen (NL); Marcus Cornelis Van Meel, Helmond (NL); Roy Hendrik Anna Maria Van Zundert, Eindhoven (NL)

(73) Assignee: KONINKLIJKE PHILIPS ELECTRONICS N.V., EINDHOVEN (NL)

(21) Appl. No.: 13/884,316

(22) PCT Filed: Nov. 4, 2011
(86) PCT No.: PCT/IB2011/054931

§ 371 Date: May 9, 2013

(30) Foreign Application Priority Data
Nov. 10, 2010 (EP) 10190595.8

(51) Int. Cl. H05B 41/38

(52) U.S. Cl. CPC H05B 41/38
USPC 315/268

(57) ABSTRACT

A method for driving and dimming an HID lamp (2), the method comprising the steps of: providing a controllable HBCF current source stage (20); using the HBCF current source stage (20) to generate commutating DC lamp current (I) having alternating current direction; supplying the HBCF current source stage (20) with an intermediate voltage (Vₒ). In normal mode, the commutating DC lamp current (I) is generated with a predetermined nominal current magnitude (I_{N}) while the intermediate voltage (Vₒ) has a predetermined nominal level (V_{N}). In a dim mode, the commutating DC lamp current (I) is generated with a current magnitude lower than said nominal current magnitude (I_{N}) while the intermediate voltage (Vₒ) has a level (V_{H}) higher than said nominal level (V_{N}).

### FIELD OF THE INVENTION

The present invention relates in general to the field of discharge lamps, particularly HID lamps, i.e. High Intensity Discharge Lamps, also indicated as high pressure discharge lamps.

### BACKGROUND OF THE INVENTION

HID lamps as such are commonly known. Therefore, an elaborate explanation is omitted here. Suffice it to say that such lamp in most cases comprises an elongate sealed discharge vessel filled with an ionizable gas filling and having two electrodes penetrating the vessel wall. Alternatively the discharge vessel can be spherical shaped. During operation, a high voltage causes a discharge, resulting in a conductive plasma allowing a lamp current between said electrodes through the ionized gas. As long as the current flows, the plasma is maintained. The amount of light generated depends on the current magnitude, and also the colour may vary with current.

In principle, it is possible that the current flows in one direction only (DC). However, this leads to undesired wear of one of the electrodes and hence a reduction of the life time of such lamp. Therefore, it has already been known for a long time to operate a lamp with alternating current direction, indicated as commutating direct current, i.e. the current magnitude remains constant but the direction is changed at a commutation frequency. The commutation frequency is typically in the order of 70-400 Hz. This type of operation is also indicated as Low Frequency Square Wave current.

HID lamps are favourable with a view to light output and energy consumption. For driving such lamps, electronic drivers are required. Several types of drivers have already been developed. One driver topology that has been proven as reliable, efficient, small size, few components and low cost is the Half-Bridge Commutating Forward (HBCF) topology. Furthermore, since the HBCF driver has become a popular driver that is much applied in lamp systems, the large-scale manufacture has further reduced costs. Therefore, it is desirable to provide a lamp system, comprising the combination of a lamp and a lamp driver, wherein the lamp is an HID lamp and wherein the driver has HBCF topology; such system will hereinafter be indicated as an HID/HBCF system.

### SUMMARY OF THE INVENTION

In use, there is a desire to be able to dim a lamp. Since the light output is typical proportional to the lamp current, dimming can be achieved by reducing the lamp current. In a HID/HBCF system a problem has been found that the HID lamp tends to extinguish when being dimmed, wherein the dim level at which the lamp extinguishes may depend on circumstances.

An objective of the present invention is to provide a solution to this problem, or in any case to reduce the lamp's tendency to extinguish.

The solution proposed by the present invention is based on an understanding of the physics behind the extinguishing problem. In an HBCF driver, a commutating current source receives power from a DC voltage source, having a suitable voltage higher than the lamp's operational voltage, which is typically in the range of 80-90 V. However, immediately after the commutation moments, the lamp's voltage briefly rises to a value that may be twice as high, and this becomes worse with reducing lamp current. When the lamp voltage reaches the output voltage of the voltage source, the current source is no longer capable to maintain the lamp current, resulting in a further increase of the lamp's voltage. Thus, the lamp current collapses: the lamp extinguishes. Based on this understanding, the present invention proposes to increase the output voltage of the DC voltage source during dimming: this will allow the current source to better maintain the lamp current and avoid extinguishing.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically shows a block diagram of a lamp system;

FIG. 2 is a graph showing lamp current and lamp voltage in normal mode as a function of time;

FIG. 3 is a graph showing lamp current and lamp voltage in dimmed mode as a function of time according to the prior art;

FIG. 4 is a graph showing lamp current and lamp voltage in dimmed mode as a function of time according to the present invention;

FIGS. 5A-5D are graphs illustrating several embodiments of a relationship between intermediate voltage and dim level.

### DETAILED DESCRIPTION OF THE INVENTION

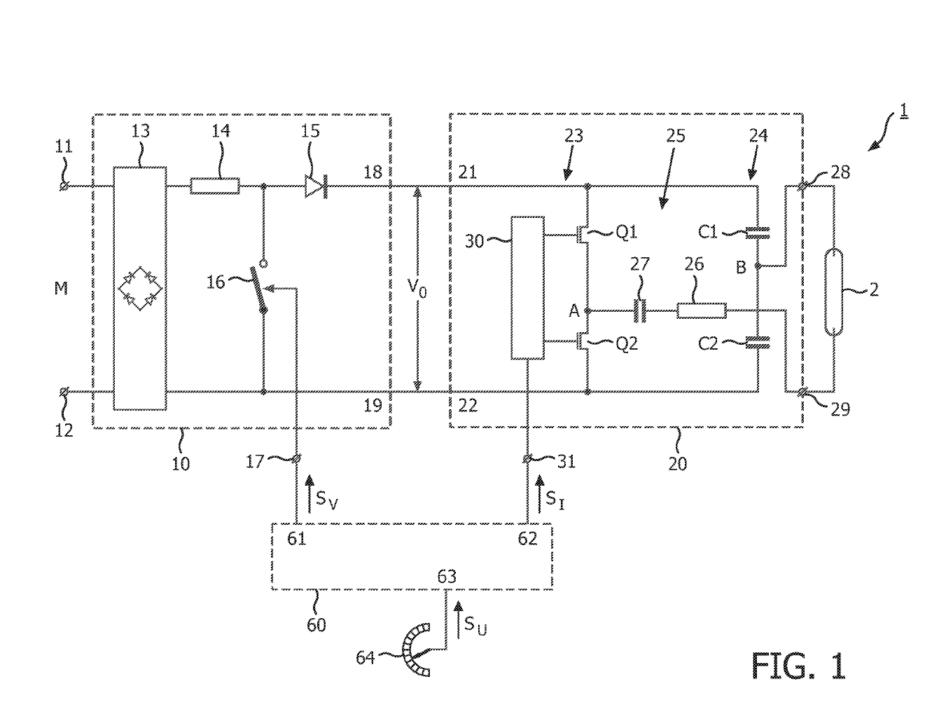

FIG. 1 schematically shows a block diagram of a lamp system 1 according to the present invention for driving an HID lamp 2. This system comprises a first stage 10, a second stage 20 and a control device 60.

The first stage 10 has input terminals 11, 12 for connecting to mains voltage M, in Europe typically 230 V @ 50 Hz, and output terminals 18, 19 for providing a DC output voltage V₀. While this is an output voltage for the first stage 10, it is not the system output voltage, therefore this voltage will hereinafter also be indicated as intermediate voltage V₀. This intermediate voltage V₀ is typically higher than the nominal mains voltage, therefore the first stage 10 is also indicated as upconverter. The first stage 10 is designed to perform the function of power factor correction, therefore the first stage 10 is also indicated as PFC stage. Upconverter stages in lamp drivers are commonly known, and a detailed description and explanation of design and operation thereof is not needed for a person skilled in the art. By way of example, the figure illustrates a buck converter design, including a series arrangement of an inductor 14 and a diode 15 and a controllable switch 16 connected to the node between inductor 14 and diode 15, but other designs are also possible. It is important that the upconverter 10 is a controllable upconverter, having a control input 17 for receiving a voltage control signal S_{V} capable of adjusting the intermediate voltage level V0: in this example, such control signal S_{V} controls the switching of the switch 16, as is known to a person skilled in the art.

The system 1 further comprises a rectifier 13 which may be an integral part of the upconverter 10, as shown, but which also may be a separate stage before the upconverter 10.

The second stage 20 has voltage rails 21, 22 connected to the output terminals 18, 19 of the upconverter 10, and output terminals 28, 29 for connection to the HID lamp 2. Since, in normal operation, the output voltage will be lower than the input voltage, the second stage 20 is also indicated as downconverter. The second stage 20 is designed to perform the function of commutating current source, and is designed as an HBCF circuit, therefore the second stage 20 is also indicated as HBCF current source. This design is commonly known, and a detailed description and explanation of design and operation is not needed for a person skilled in the art; by way of example, reference is made to WO-2008/072136. Suffice it so say that the HBCF current source 20 comprises a first series arrangement 23 of two controllable switches Q1, Q2 connected between said two voltage rails 21, 22, a second series arrangement 24 of two capacitors C1, C2 connected between said two voltage rails 21, 22, and a third series arrangement 25 of said output terminals 28, 29, an inductor 26 and a capacitor 27 connected between on the one hand a node A between said two controllable switches Q1, Q2 and on the other hand a node B between said two capacitors C1, C2. It is important that the HBCF current source 20 is a controllable current source, having a control input 31 for receiving a current control signal S_{I} capable of adjusting the output current magnitude: in this example, such control signal S_{I} controls the switching of the switches Q1, Q2, as is known to a person skilled in the art.

It is to be noted that the HBCF current source 20 may include a switch controller 30, receiving a single control signal S_{I} and generating individual control signals for the switches Q1, Q2, as shown. However, it is also possible that the HBCF current source 20 receives two separate control signals for direct connection to the individual switches Q1, Q2, in which case the combination of such two separate control signals will be indicated as “the current control signal”.

The system 1 further comprises a control device 60, having a voltage control output 61 coupled to the control input 17 of the controllable upconverter 10 and a current control output 62 coupled to the control input 31 of the controllable HBCF current source 20. Typically, the control device 60 will also have a user input 63 for receiving a user input signal S_{U} that is indicative for a desired dim level. The user input signal S_{U} may be generated by a user-operable input device 64 such as for instance a potentiometer associated with the control device 60, but it is also possible that the user input signal S_{U} is generated by a higher ranking control device or by a receiver of a remote control system.

It is noted that the controllable upconverter 10 and the controllable HBCF current source 20 may in fact be standard components. Persons skilled in the art will know what type of control signals are needed, and how these control signals should be adapted to obtain a certain desired intermediate voltage level V₀ and a certain desired output current magnitude, so that it is not necessary to explain these details here.

The lamp system 1 is designed for driving a specific type of lamp and has a certain nominal rating, corresponding to a certain nominal energy consumption, a certain nominal light output of the specific lamp type, a certain nominal lamp current magnitude I_{N} and a certain nominal value V_{N} for the intermediate voltage level V₀. The control device 60 is capable of operating in a normal mode in which it generates its control signals S_{V} and S_{I} such that these nominal specifications are met. It is noted that such nominal control signals may be fixed, set by the manufacturer, but it is also possible that the lamp system 1 comprises a voltage sensor for measuring the actual intermediate voltage level V₀ and a current sensor for measuring the actual output current, in which case these sensors provide feedback signals to the control device 60 and the control device 60 adapts its control signals S_{V} and S_{I} such that the actual intermediate voltage level V₀ and the actual output current are equal to the desired target values, but this is not shown for sake of convenience.

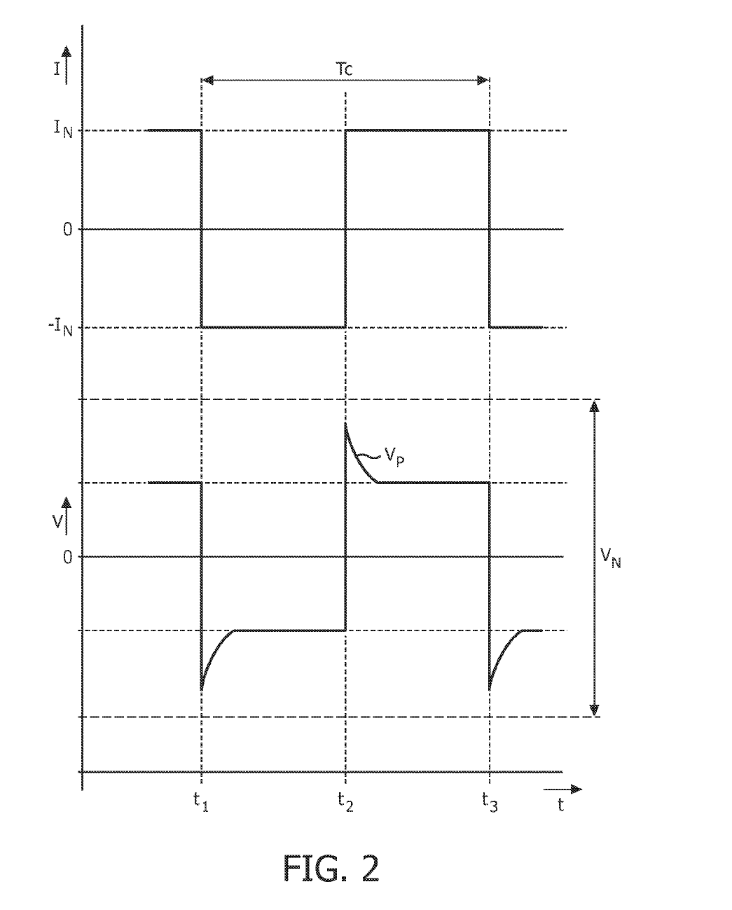

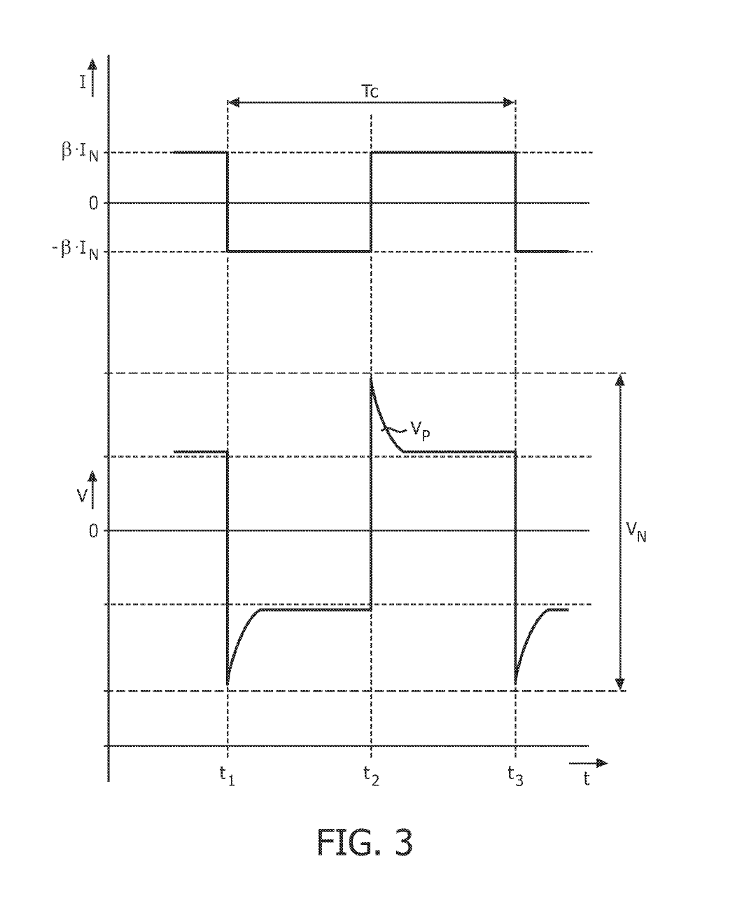

The operation of the system will now be explained with reference to FIGS. 2 and 3. FIG. 2 is a graph showing output current and output voltage (i.e. lamp current and lamp voltage) in normal mode as a function of time. The figure shows that the lamp current has a constant nominal magnitude I_{N} (a possible small current ripple is not shown) but changes direction at commutation moments t1, t2, t3, etc, with a commutation period Tc and a commutation frequency fc=1/Tc, which may be in the range of about 70 to about 400 Hz. FIG. 2 also shows that the lamp voltage shows a similar waveform of a constant value that changes sign in synchronisation with the lamp current.

It is noted that commutation is not infinitely fast, as suggested by the figure, but actually takes some commutation time, but this is not shown for sake of convenience. During commutation, therefore, the current magnitude reduces to zero and then rises again to the nominal value I_{N}. Within this brief commutation duration, the plasma in the lamp is not sustained as normal, and the discharge in the lamp is tending to stop. After commutation, therefore, the discharge requires a boost in the form of a re-ignition voltage pulse Vp; this is also shown in the figure.

Due to the lamp characteristics, the voltage drop over the lamp will substantially have a constant value. The precise value of this constant voltage drop may depend on the specific lamp parameters such as size and materials used, but is typically in the range of 80-90 V. The re-ignition voltage pulse Vp may typically have an amplitude of about 160 V. While the precise value of the intermediate voltage V₀ is not critical, it must be set such as to be larger than twice the expected value of the re-ignition voltage pulse Vp in order to accommodate for the positive and the negative pulse, and there should be some margin left. On the other hand, with higher values of the intermediate voltage V₀, dissipation losses in the system increase and the temperature of the components rises, so it is desirable to keep the intermediate voltage V₀ low. In practice, the intermediate voltage V₀ is typically set to have a nominal value V_{N} of about 400 V.

The control device 60 is also capable of operating in a dim mode in which it generates its control signals S_{V} and S_{I} such that the light output is less than nominal. More dimming will mean less light. In order to avoid misunderstandings, a dim level β will be defined in a range from 0 to 1 (or 0% to 100%), wherein a dim level 0 corresponds to full dimming and hence zero light output and wherein a dim level 1 corresponds to no dimming and hence nominal light output.

Persons skilled in the art will realize that there is a relationship between current magnitude and light output. It is possible to consider dimming with a view to the observer, in terms of light output; in such interpretation, a “dim level β” will mean that the actual light output level is β times the nominal light output level which corresponds to a lowered current magnitude which is not necessarily equal to β times the nominal current magnitude. It is also possible to consider dimming with a view to the current control; in such interpretation, a “dim level β” will mean that the actual current magnitude is β times the nominal current magnitude which corresponds to a lowered light output level which is not necessarily equal to β times the nominal light output level. These approaches are considered to be equivalent: if the current is dimmed by a factor β1, the light will be dimmed by a factor β2, where β2 may be unequal to β1, and wherein the ratio β2/β1 does not have to be constant. For sake of convenience in explaining the invention, it is assumed in the following that the light output is directly proportional to the current magnitude, which in practice does not need to be the case.

FIG. 3 is a graph comparable to FIG. 2 illustrating dim operation. Dimming is performed by reducing the current magnitude: therefore, the figure shows that the lamp current has a constant magnitude β·I_{N}. In view of the lower lamp current, the temperature of the lamp electrodes will be lower, resulting in an increase of the voltage drop over the lamp. Further, re-ignition of the discharge after commutation will be more difficult, requiring a higher re-ignition voltage pulse Vp. All in all, the margin between the intermediate voltage V₀ and the top-top distance between the positive and negative re-ignition voltage pulses has reduced.

In prior art systems, during dimming, the intermediate voltage V₀ is maintained constant at the nominal value V_{N}. With reducing dim level, it becomes more difficult for the HBCF current source to actually produce the desired output current at the required output voltage. Undesirable flicker may occur, and the lamp may even extinguish. Since this is clearly undesirable, the dim level may not be reduced to values where such phenomena occur; in other words, the allowable dim range is limited.

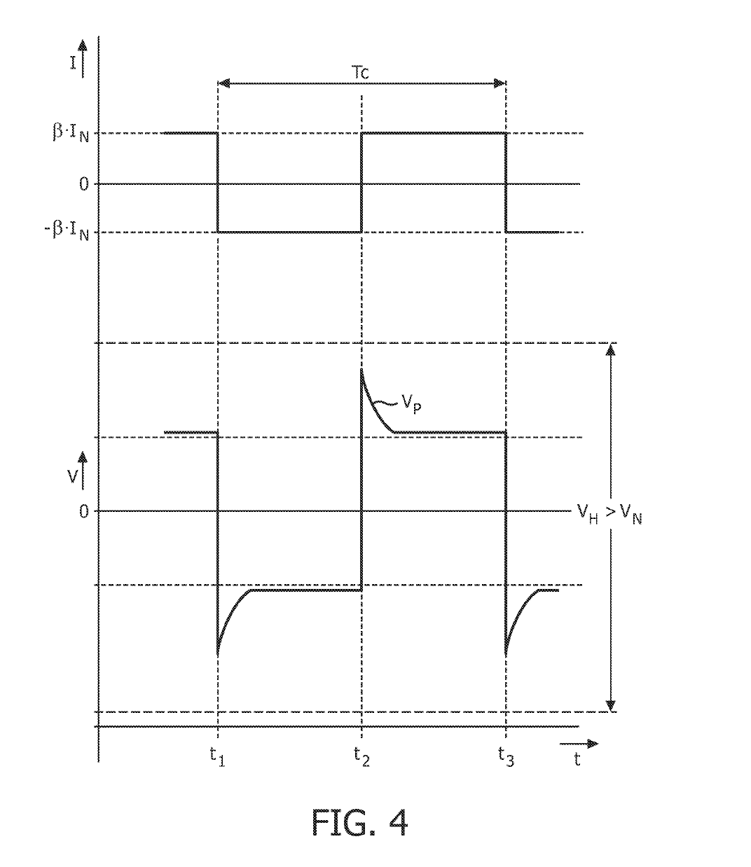

FIG. 4 is a graph comparable to FIG. 3, illustrating dim operation according to the present invention. In order to avoid or at least reduce the above-mentioned problem, the control device 60 is designed, in the dim mode, to generate its voltage control signal S_{V} such as to increase the intermediate voltage V₀ to a value V_{H} higher than the nominal value V_{N}. In a suitable embodiment, this value V_{H} is 30% higher than V_{N}.

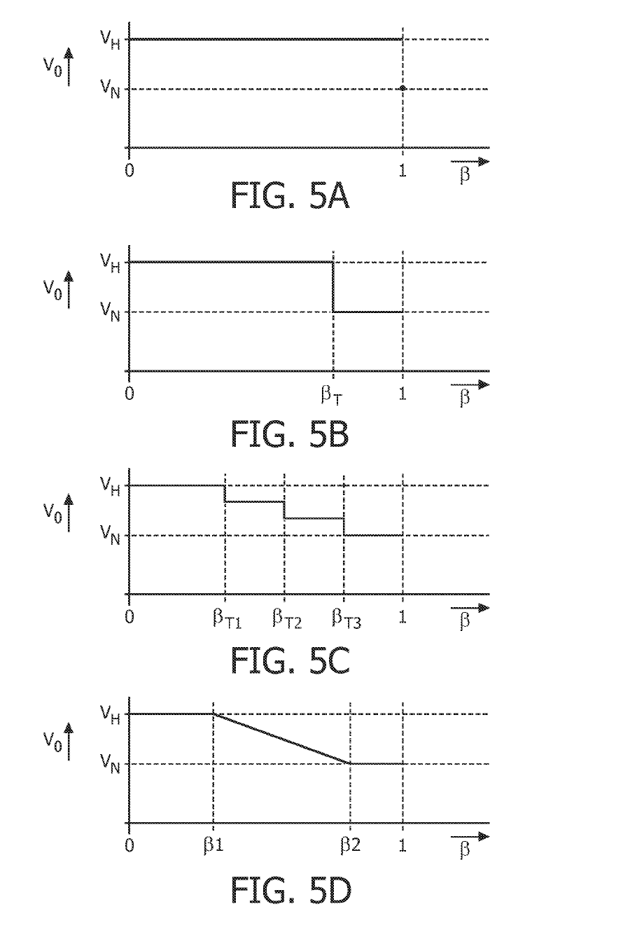

There are several methods possible for implementing this invention, which will be explained with reference to FIGS. 5A-5D, which are graphs illustrating a relationship between intermediate voltage V₀ and dim level β.

In one embodiment, the intermediate voltage V₀ is always increased to said higher value V_{H} when in dim mode, irrespective of the actual dim level, i.e. for all values of β<1 (see FIG. 5A). However, it seems justified to consider that such increase is not needed for dim levels close to 1. So, in another embodiment, a dim level threshold β_{T} is defined, and the intermediate voltage V₀ is always set at the nominal value V_{N} for β_{T}<β<1 and set at the increased value V_{H} for all values of β<β_{T} (see FIG. 5B). For β=β_{T}, the intermediate voltage V0 may be either equal to V_{N} or to V_{H}.

In yet another embodiment, it is considered that the desire for increasing V₀ becomes stronger with decreasing dim level. Therefore, multiple thresholds β_{T1}, β₂, β_{T3} etc may be defined, while always the intermediate voltage V₀ is constant between two neighbouring thresholds whereas the intermediate voltage V₀ for β lower than one such threshold is higher than for β higher than the same threshold (see FIG. 5C). The distances between thresholds do not have to be mutually equal, and the voltage steps at the different thresholds do not have to be mutually equal.

Especially in applications where the dim level may be gradually reduced or increased, but not restricted to such applications, it is preferred not to use a step-wise transition from one discrete voltage value to another discrete voltage value when passing a certain dim level value. Thus, in another embodiment, the intermediate voltage V₀ is a continuous function of the dim level β. FIG. 5D illustrates an embodiment where a dim level range is defined between two border values β1 and β2. Within this range, the intermediate voltage V₀ may be linearly proportional to p, i.e. dV₀/dβ is constant. The higher border value β2 may be equal to 1, and/or the lower border value β1 may be equal to zero.

Instead of a linear relationship, a progressive or curved relationship is possible, with the concave side of the curve being directed either upwards or downwards. Also an S-shaped curve is possible.

Further, it is possible to have two or more of such ranges, wherein the relationship within one range differs from the relationship within another range.

In an experimentally tested embodiment, considered to be adequate, there are two ranges.

Within the first range, from β=0 to β=β_{T}, the intermediate voltage V₀ is always equal to V_{H}.

Within the second range, from β=PT to β=1, the intermediate voltage V₀ is proportional to β in accordance with the formula

$${V}_{0} = \frac{( {V}_{H} - {V}_{N} ) \cdot ( 1 - β )}{( 1 - {β}_{T} )}$$

This corresponds to the embodiment of FIG. 5D, with β2=1.

In the experimentally tested embodiment, β_{T} was set at 0.8, V_{N} was equal to 400 V, and V_{H} was equal to 520 V.

In the above, the dimmed state has been described as a steady state. In the following, a transition from a first dim level to a second dim level will be considered. When this transition is done slowly, it will be allowable at all times during the transition to consider the momentary state as being a steady state. When the transition is done quickly, it is better to take a different approach. When the second dim level is higher than the first dim level, the current magnitude at the second dim level has increased and the intermediate voltage may be lowered from a first value corresponding to the first dim level to a second value corresponding to the second dim level; it is preferred to lower the intermediate voltage after the transition to the second dim level has been completed. Conversely, when the second dim level is lower than the first dim level, the current magnitude at the second dim level has decreased and the intermediate voltage may need to be increased from a first value corresponding to the first dim level to a second value corresponding to the second dim level; it is preferred to increase the intermediate voltage from said first value to said second value before lowering the dim level.

Summarizing, the present invention provides a method for driving and dimming an HID lamp 2, the method comprising the steps of:

providing a controllable HBCF current source stage 20;

using the HBCF current source stage 20 to generate commutating DC lamp current I having alternating current direction;

supplying the HBCF current source stage 20 with an intermediate voltage V₀. In normal mode, the commutating DC lamp current I is generated with a predetermined nominal current magnitude I_{N} while the intermediate voltage V₀ has a predetermined nominal level V_{N}.

In a dim mode, the commutating DC lamp current I is generated with a reduced current magnitude lower than said nominal current magnitude I_{N} while the intermediate voltage V₀ has an increased level V_{H} higher than said nominal level V_{N}.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

It is further noted that in the above explanation the current magnitude, in steady state, is assumed to be substantially constant as a function of time. However, even in normal mode, and the same applies to dim mode, it may be desirable that the current magnitude is varied as a function of time. Such variation may for instance be a quick increase of the current magnitude immediately before commutation in order to make re-ignition easier. It is not necessary, and would actually be counter productive, if in such case the intermediate voltage would be briefly lowered in synchronisation with such current peak. On the other hand, such variation may for instance be a gradual increase/decrease on a time scale in the order of minutes, in any case longer than the mains period.

A slow variation is typically executed when illumination is switched from one dim level to another in a manner such as to be hardly noticeable to the human eye. Such variation takes place on a time scale of minutes, in any case much longer than the mains period. In such case, the control device will adapt the intermediate voltage in the manner described above. Variations taking place between two consecutive commutation moments, i.e. on a time scale much less than the mains period, will not be followed by the control device: in principle, the intermediate voltage level is kept constant in the time interval between two consecutive commutation moments. For implementing the present invention, the intermediate voltage level can be calculated on the basis of the average current magnitude, averaged over the time between two consecutive commutation moments. It is also possible that the intermediate voltage level is calculated on the basis of the lowest current magnitude occurring in the time interval between two consecutive commutation moments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Lamp system for driving a HID lamp, the system comprising:
a controllable upconverter voltage source stage designed to provide an intermediate voltage;
a controllable HBCF current source stage, having voltage rails connected to receive the intermediate voltage, and having output terminals connected to the lamp, the current source stage being designed to generate commutating DC lamp current having alternating current direction;
a control device for controlling the upconverter stage and the current source stage;
the control device being capable of operating in a normal mode and in a dim mode,
the control device being designed to generate control signals for the upconverter stage and the current source stage, respectively, such that the intermediate voltage has a predetermined nominal value and the lamp current has a predetermined nominal magnitude when operating in normal mode;
and the control device being designed to generate the current control signal that the lamp current has a magnitude lower than the nominal current magnitude, when operating in the dim mode, β being designating a dim level in a range from 0 to 1; the control device being further designed to generate the voltage control signal so that the intermediate voltage has a value higher than the nominal intermediate voltage level for at least a range of values of the dim level.

2. System according to claim 1, wherein the intermediate voltage has the higher value for all values of β<1.

3. System according to claim 1, wherein the intermediate voltage has the higher value for all values of β<β_{T} and has the nominal value for all values of β in the range β_{T}<β<1, with β_{T} indicating a predetermined threshold dim level.

4. System according to claim 1, having at least one predetermined threshold dim level, wherein the intermediate voltage has a higher value for a dim level lower than such threshold dim level and a lower value for a dim level higher than the same threshold dim level.

5. System according to claim 1, having at least two predetermined threshold dim levels, wherein the intermediate voltage has a constant value for all values of β in between two successive threshold dim levels.

6. System according to claim 1, having at least one dim range between two predetermined border values β1 and β2, wherein, within such dim range, the intermediate voltage is a continuous function of the dim level β, wherein one of said border values may be equal to 0 and/or wherein one of said border values may be equal to 1.

7. System according to claim 6, wherein said continuous function is a linear function.

8. System according to claim 1, having a dim range between 0 and a predetermined first border value β1 in which the intermediate voltage always has the higher value, and having a dim range between 1 and a predetermined second border value β2 in which the intermediate voltage always has the nominal value.

9. Method for driving and dimming an HID lamp, the method comprising the steps of:
providing a controllable HBCF current source stage;
using the HBCF current source stage to generate commutating DC lamp current having alternating current direction;
supplying the HBCF current source stage with an intermediate voltage;
in normal mode, generating the commutating DC lamp current with a predetermined nominal current magnitude while the intermediate voltage has a predetermined nominal level;
and in a dim mode, generating the commutating DC lamp current with a current magnitude lower than said nominal current magnitude while the intermediate voltage has a level higher than said nominal level.

10. Method according to claim 9, wherein the HID lamp is dimmed by gradually reducing the current magnitude, and wherein the intermediate voltage is increased stepwise when passing a predetermined threshold dim level.

11. Method according to claim 9, wherein the HID lamp is dimmed by gradually reducing the current magnitude, and wherein, at least within a certain dim range, the intermediate voltage is increased continuously in proportion with the reduction of the current magnitude.

12. Method according to claim 9, wherein the HID lamp is dimmed by reducing the current magnitude from a first value to a second value, and wherein the intermediate voltage is increased to a voltage value corresponding to the second current value before the current magnitude is decreased.

13. Method according to claim 9, wherein dimming of the HID lamp is reduced by increasing the current magnitude from a first value to a second value, and wherein the intermediate voltage is decreased to a voltage value corresponding to the second current value after the current magnitude has increased.
